(19) United States
(12) Patent Application Publication
(10) Pub. No.: US 2012/0060331 A1
(43) Pub. Date: Mar. 15, 2012

(54) HOOK ASSEMBLY FOR A SUNSHADE SCREEN

(75) Inventor: Paul LIN, Yung-Kang City (TW)

(73) Assignee: MACAUTO INDUSTRIAL CO., LTD., Yung-Kang City (TW)

(21) Appl. No.: 12/878,854

(22) Filed: Sep. 9, 2010

(51) Int. Cl. F16B 45/00; F16B 2/20

(52) U.S. Cl. 24/457

(57) ABSTRACT

A hook assembly is adapted to be mounted on a sunshade screen. The hook assembly includes a side strip unit and a hook member. The side strip unit includes a first side strip extending along a longitudinal direction, and a second side strip extending along the longitudinal direction and cooperating with the first side strip for clamping the sunshade screen therebetween. The hook member includes an engaging portion detachably and slidably engaging the first side strip, and a hook portion extending from the engaging portion and exposed from the side strip unit.

### BACKGROUND OF THE INVENTION

1. Field of the Invention

The invention relates to a hook assembly, more particularly to a hook assembly for a sunshade screen.

2. Description of the Related Art

A conventional hook assembly for a sunshade screen of a vehicle comprises a side strip 1 mounted on a distal end of the screen (not shown), and at least one hook 2 attached to the side strip 1 and capable of being hooked on a portion of the vehicle (not shown) to thereby maintain the screen at an extended state.

However, such hook 2 is generally secured threadedly to the side strip 1 through a plurality of screws 20, which results in inconvenience when the conventional hook assembly is assembled to and disassembled from the sunshade, and increase of the manufacturing cost of the sunshade.

### SUMMARY OF THE INVENTION

Therefore, the object of the invention is to provide a hook assembly capable of alleviating the above drawbacks of the prior art.

Accordingly, a hook assembly of the present invention is adapted to be mounted on a sunshade screen, and comprises a side strip unit and a hook member. The side strip unit includes a first side strip extending along a longitudinal direction, and a second side strip extending along the longitudinal direction and cooperating with the first side strip for clamping the sunshade screen therebetween. The hook member has an engaging portion detachably and slidably engaging the first side strip, and a hook portion extending from the engaging portion and exposed from the side strip unit.

### BRIEF DESCRIPTION OF THE DRAWINGS

Other features and advantages of the invention will become apparent in the following detailed description of the preferred embodiment with reference to the accompanying drawings, of which:

FIG. 1 is a perspective view of a conventional hook assembly for a sunshade screen;

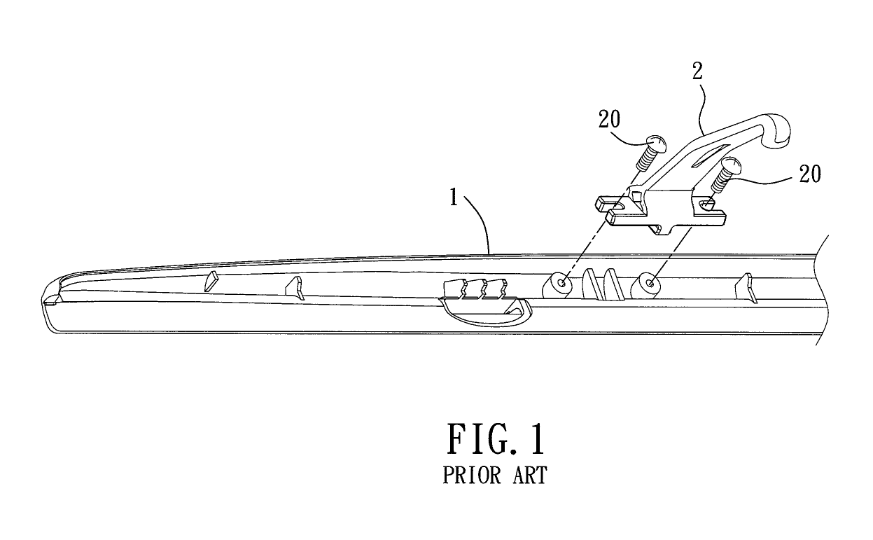

FIG. 2 is a perspective view of a sunshade screen mounted with a preferred embodiment of a hook assembly according to the present invention;

FIG. 3 is an exploded perspective view of the preferred embodiment;

FIG. 4 is an enlarged fragmentary exploded perspective view of a preferred embodiment; and

FIG. 5 is a sectional view of the first preferred embodiment;

FIG. 6 is another sectional view of the preferred embodiment.

### DETAILED DESCRIPTION OF THE PREFERRED EMBODIMENTS

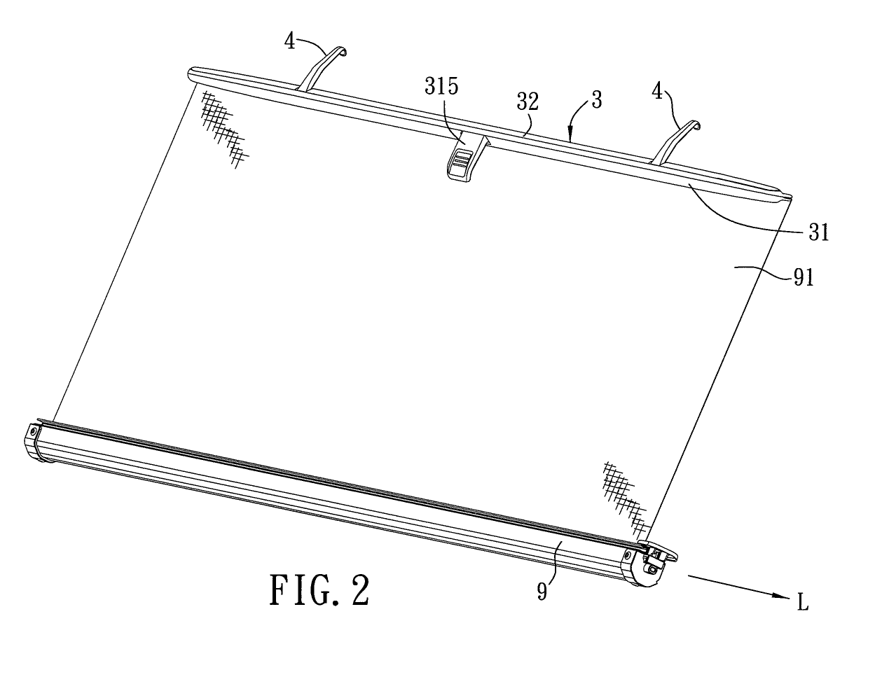

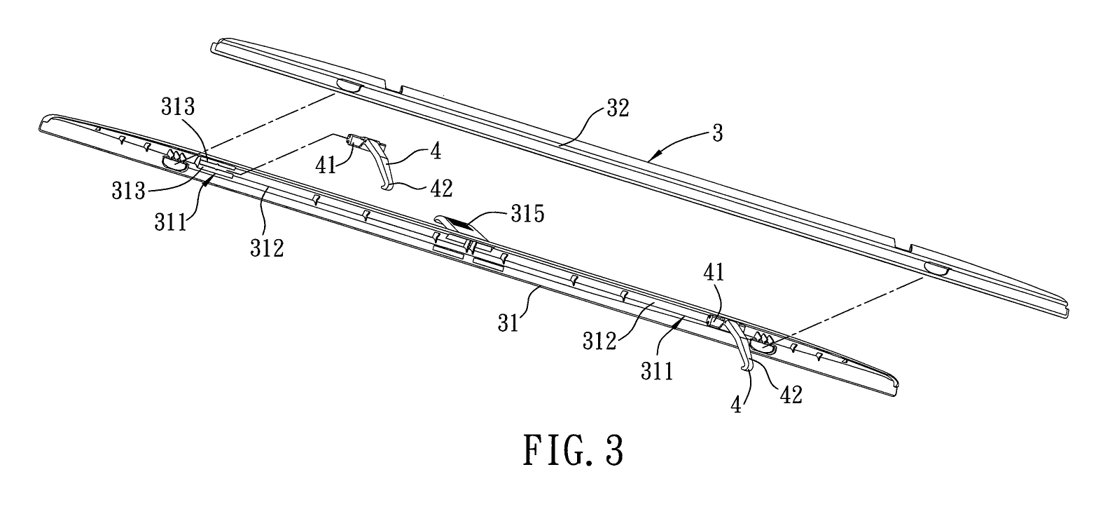

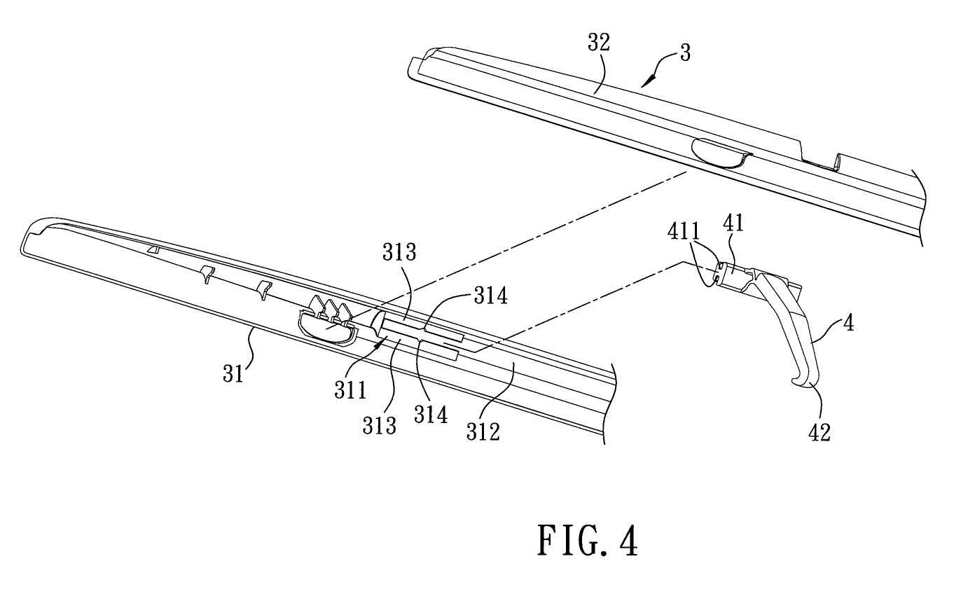

Referring to FIGS. 2 to 4, a preferred embodiment of a hook assembly according to the present invention is adapted to be mounted on a sunshade screen 91 of a sunshade and hooked on a vehicle (not shown). The hook assembly comprises a side strip unit 3 and two hook members 4.

The side strip unit 3 includes a first side strip 31 extending along a longitudinal direction (L), and a second side strip 32 extending along the longitudinal direction (L) and cooperating with the first side strip 31 for clamping a distal portion of the sunshade screen 91 therebetween. The first side strip 31 has one side that is formed with two engaging parts 311 and an opposite side that is formed with a handle 315. Each of the engaging parts 311 has a slot 312 and a pair of spaced-apart engaging ribs 313. The slot 312 of each of the engaging parts 311 of the first side strip 31 extends along the longitudinal direction (L) and faces the second side strip 32. The engaging ribs 313 of each of the engaging parts 311 are formed in the slot 312 of a corresponding one of the engaging parts 311, extend toward each other, and are formed respectively with two positioning recesses 314.

Each of the hook members 4 has an engaging portion 41 and a hook portion 42. The engaging portion 41 of each hook member 4 engages detachably and slidably a respective one of the engaging parts 311 of the first side strip 31, and is formed with two slide grooves 411 that extend along the longitudinal direction (L) and that engage respectively and slidably the engaging ribs 313 of the respective one of the engaging parts 311. The engaging portion 41 of each hook member 4 is further formed with two positioning protrusions 412 disposed respectively in the slide grooves 411 for engaging detachably and respectively the positioning recesses 314 of the engaging ribs 313 of the corresponding one of the engaging parts 311 so as to position the hook member 4 relative to the first side strip 31. The hook portion 42 of each hook member 4 extends from the engaging portion 41 of the corresponding hook member 4 and is exposed from the side strip unit 3.

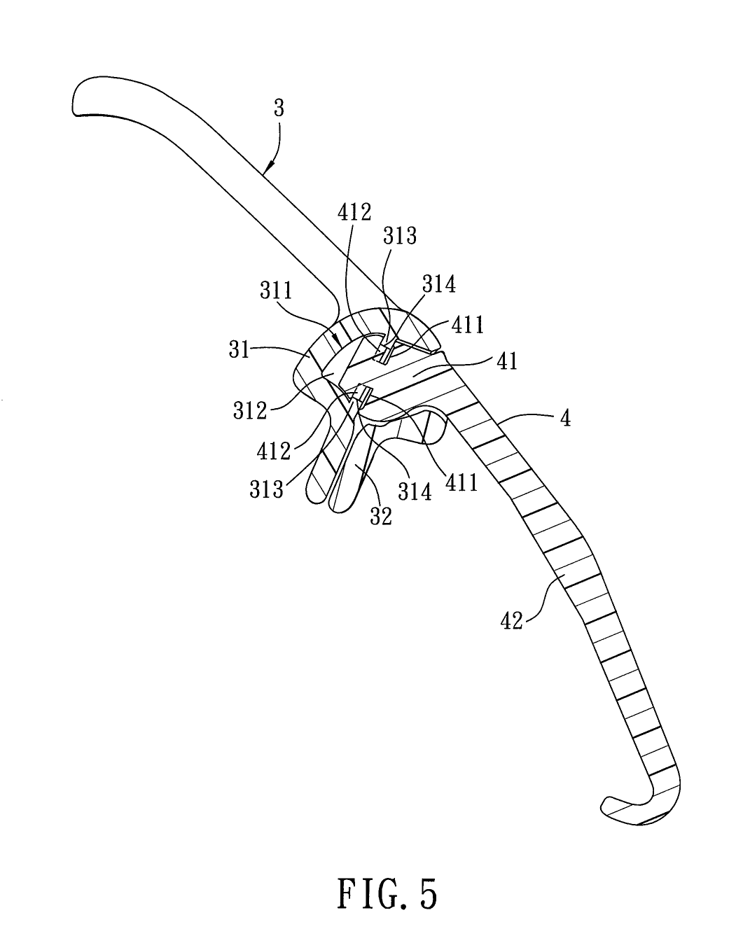

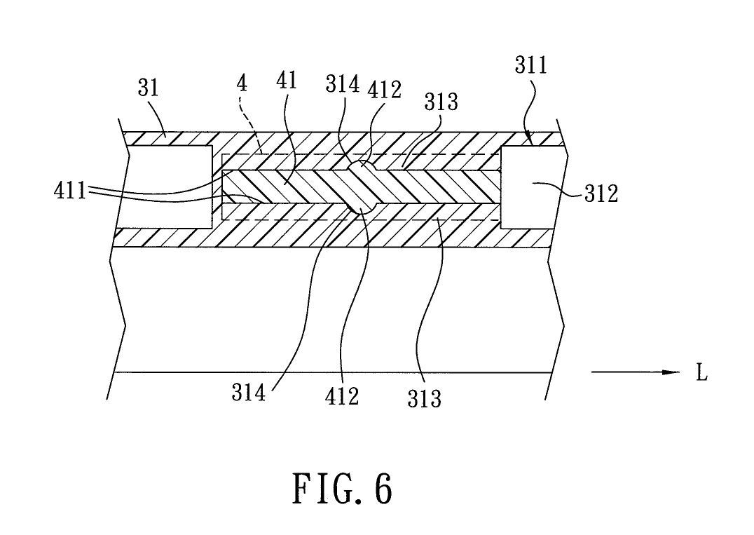

Further referring to FIGS. 5 and 6, when assembling the hook members 4 to the side strip unit 3, the engaging portion 41 of each of the hook members 4 is inserted into the slot 312 of the corresponding one of the engaging parts 311 of the first side strip 31, and is pushed along the longitudinal direction (L) to allow the slide grooves 411 of the engaging portion 41 of each of the hook members 4 to engage slidably and respectively the engaging ribs 313 of the corresponding one of the engaging parts 311 of the first side strip 31 until the positioning protrusions 412 of the engaging portion 41 of each of the hook members 4 engage respectively the positioning recesses 314 of the engaging ribs 313 of the corresponding one of the engaging parts 311. As a result, the hook members 4 are positioned relative to the first side strip 31. Then, the second side strip 32 is coupled to and cooperates with the first side strip 31 for clamping the sunshade screen 91 therebetween and covering the engaging parts 311 and the engaging portion 41 of each of the hook members 4.

When disassembling the hook members 4 from the side strip unit 3, each of the hook members 4 is pushed to move relative to the first side strip 31 to result in disengagement of the engaging portion 41 of each of the hook members 4 from the corresponding one of the engaging parts 311 of the first side strip 31.

It should be noted that the positioning protrusions 412 of the engaging portion 41 of each of the hook members 4 and the positioning recesses 314 of the engaging ribs 313 of the engaging part 311 may be omitted in other embodiments of this invention. For example, the engaging ribs 313 may be configured to be inserted fittingly and respectively into the slide grooves 411 (i.e., the engaging ribs 313 are in frictional contact with the engaging portions 41) so as to position the hook members 4 relative to the first side strip.

To sum up, the advantages of the hook assembly according to the present invention are as follows. In this embodiment, the configurations of the engaging parts 311 of the first side strip 31 and the engaging portions 41 of the hook members 4 provide a detachable engagement between the first side strip 31 and the hook members 4 without the use of screws and a screwdriver. Therefore, it is convenient for users to assemble the hook members 4 to the first side strip 31 and the manufacturing cost of the hook assembly of this invention can also be reduced.

1. A hook assembly adapted to be mounted on a sunshade screen (91), said hook assembly being comprising:
a side strip unit (3) including
a first side strip (31) that extends along a longitudinal direction (L), and
a second side strip (32) that extends along the longitudinal direction (L) and that cooperates with said first side strip (31) for clamping the sunshade screen (91) therebetween; and
a hook member (4) including
an engaging portion (41) that detachably and slidably engages said first side strip (31), and
a hook portion (42) that extends from said engaging portion (41) and that is exposed from said side strip unit (3);
wherein the first side strip (31) has an engaging part (311) engaging detachably and slidably the engaging portion (41) of the hook member (4), and having
a slot (312) that extends along the longitudinal direction (L) and that faces the second side strip (32), and
two spaced-apart engaging ribs (313) that are formed in the slot (312) and that extend toward each other,
the engaging portion (41) of the hook member (4) being formed with two slide grooves (411) that extend along the longitudinal direction (L) and that engage respectively and slidably the engaging ribs (313) of the engaging part (311) of the first side strip (31); and
wherein one of the engaging ribs (313) of the engaging part (311) of the first side strip (31) is formed with a positioning recess (314), and the engaging portion (41) of the hook member (4) is formed with a positioning protrusion (412) that detachably engages the positioning recess (314) to position the hook member (4) relative to the first side strip (31).

2. (canceled)

3. (canceled)
